(19) United States
(12) Patent Application Publication
(10) Pub. No.: US 2003/0069881 A1
(43) Pub. Date: Apr. 10, 2003

(54) Apparatus and method for dynamic partitioning of structured documents

(75) Inventor: Sampo Huttunen, Oulu (FI)

Correspondence Address: Michael C. Stuart, Esq,, Cohen, Pontani, Lieberman & Pavane, Suite 1210, 551 Fifth Avenue, New York, NY, 10176, US

(73) Assignee: Nokia Corporation

(21) Appl. No.: 09/969,846

(22) Filed: Oct. 3, 2001

(51) Int. Cl. G06F 7/00

(52) U.S. Cl. 707/5

(57) ABSTRACT

A structured document is partitioned to produce a fragment for output to a mobile device for rendering and display on the device. The fragment includes forward and backward links to allow the user of the device to navigate the document by requesting fragments of previous or subsequent context in the document hierarchy. Prior to partitioning, elements of the document are automatically annotated with device-independent metadata. The annotating is based on a mapping between the metadata and structural rules that apply to that document and a group of similarly structured documents. User preferences, architectural limitation parameters, and the partitioning direction are included in a request from the device, and with predetermined partitioning rules, are used to partition the annotated document to yield the displayable fragment.

### BACKGROUND OF THE INVENTION

1. Field of the Invention

The present invention is directed to partitioning of structured documents, and more particularly to partitioning of structured documents into semantically coherent fragments.

2. Description of the Related Art

As the use of the World Wide Web for the delivery of documents increases, the requirements for those documents increase as well. Documents are read for a certain purpose, usually to find the information needed for the situation at hand. In such event, the document's users prefer to find the needed information quickly and without need to read through the entire document, most of which is probably of no use to them at the moment. There is therefore a need to supply context-sensitive fragments of the original document that contain only the needed information and omit the rest.

The Internet is also facing a growing need for delivering of content to terminals such as cellular phones or Personal Digital Assistants (PDAs) that have wireless access to the Internet. That need sets new kinds of requirements for content delivery, since although the user devices employed for accessing documents vary in many ways, the same content should be available for all of them. For example, wirelessly connected portable terminals have very different preferences from typical desktop computers for pushing content to or pulling content from a remote location via the Internet. As stated in the WAP White Paper [WAP White Paper, Wireless Application Protocol Forum Ltd, http://www.wapforum.org/what/whitepapers.htm (October 1999)]:

Wireless devices represent the ultimate constrained computing device with limited CPU, memory, and battery life, and a simple user interface. Wireless networks are constrained by low bandwidth, high latency, and unpredictable availability and stability. However, most important of all, wireless subscribers have a different set of essential desires and needs than desktop or even laptop Internet users.

By definition, portable terminals are usually very small when compared to desktop computers; otherwise no one would wish to carry them around. Hence they have smaller screens, often lower resolution, and other restrictions in their ability to use the rich media features available today in browsing web content via desktop computers. Limited rendering capability causes problems in accessing the web contents.

What is needed is a means to transcode the existing, inaccessible content into documents that can be accessed by and viewed on wireless terminals.

In many cases, pure content type transcoding, e.g. from Hyper Text Markup Language (HTML) to Wireless Markup Language (WML), is not enough because of the constraints of portable terminals, such as small screens, but it is also necessary to partition the original document into smaller fragments that can be handled by the terminal. A fragment, as the term is used herein, is a portion of document which results from partitioning or parsing of the document for transmission to a user's device for rendering and display thereon. Partitioning is often also needed also with desktop computers when, for example, a document to be viewed may be hundreds of pages long. Therefore, partitioning is needed for all user devices, but especially for those with limited rendering capabilities.

In addition to accessibility issues, an intelligent way of document partitioning can also have a major usability impact on documents. If a partitioning system is capable of delivering document fragments that are coherent by their content, while still providing enough information about the fragment's context, in a form that is best suited for a specific user device and conforms to user preferences, it is reasonable to presume that it is more usable than a monolithic, static document that is delivered as such to all user devices.

Extensible Markup Language (XML) fragment interchange is a work in progress within W3C (The World Wide Web Consortium) that may make a significant contribution in solving this problem. It is an outcome of the XML Fragment Workgroup of W3C, which “is chartered with defining a way to send fragments of XML document—regardless of whether the fragments are predetermined entities or not without having to send all of the containing document up to the part in question.” XML-fragment 99 [Extensible Markup Language (XML) 1.0 W3C Recommendation, http://www.w3org/TR/1998/REC-xml-19980210 (February 1998). Interchange of XML fragments proposes a formal scheme to provide the recipient of an XML fragment with the appropriate information about the context that fragment had in the larger document which is not available to the recipient. That context information will enable interchange of fragments on the recipient user device without the need to parse the entire XML document up to the part in question.

NEC Corporation has sent W3C a Note for discussion about navigation, called XML Document Navigation Language [XML-navigation 00, Frequently Asked Questions about the Extensible Markup Language. Version 1.6, Http://www.ucc.ie/xml/ (July 2000)]. The Note addresses the need for providing navigational methods for a combination of a large document and a small user device. However, the Note does not discuss partitioning other than suggesting that a document be divided such that each element is its own fragment. As used in the Note, an “element” is a document structuring unit that is limited by tags in the mark-up. The Note then discusses how navigation between those fragments should be done and introduces a vocabulary for distinguishing navigation from content, but the Note lacks explicit description of how the fragments' context should be managed. The Note does not offer a useful method for document partitioning.

XML documents consist of nodes. There are seven types of nodes: root, element, text, attribute, namespace, processing instruction, and comment nodes. Of these seven, root and element nodes are elements. Hereinafter, the terms “node” and “element” will be used interchangeably, except where a distinction is indicated. At times, the term “element node” will be used indicate a node that is an element.

The XML standard supports composition of documents from several entities. Sometimes, as is the case in document partitioning, only parts of the original document are viewed at a time. While viewing only a part of a document, there must be a means to access the information about the context that the fragment had in the parent document; otherwise, one cannot easily navigate between fragments, use stylesheets or perform any other context-sensitive tasks. Another important request in the delivery of fragments of documents is to be able to parse the fragment correctly. Therefore, all parsing-sensitive information of the parent document must also be transmitted. One way to send an XML fragment without having to send all of the original document up to the location of the fragment is described in XML Fragment Interchange, W3C Working Draft, http:/www.w3.org/TR/WD-xml-fragment (July 1999). That goal is especially important for small user agents with limited rendering capabilities, and particularly when the original document is large. (Hereinafter the term “user agent” will be used, in a general sense, to represent an implementation that retrieves and processes documents.) Examples of user agents are browsing applications, such as Netscape Navigator or Microsoft Internet Explorer, and devices such as a WAP (Wireless Application Protocol)-enabled mobile phone. A small user agent might be used, for example, when a technician is dispatched to repair a network base station and he or she needs access to the manual, while in the field. Such a manual might be hundreds of pages long, and the technician may have only a WAP-enabled mobile phone for use in viewing the manual. In such a case, it is desirable to partition the document into small fragments but, at the same time, manage those fragments so that it is possible to navigate within the original large document.

In the fragmentation process, the object that is transmitted between the server and the user device is called a “fragment entity”. A fragment entity contains the object representing the fragment which has been removed from the source document. That object is called a “fragment body”. What is still needed is the context information of the fragment body in the original document. That information is constructed using the notation of XML Fragment Interchange and is called “fragment context specification” (fcs). Fcs can be transmitted inside a fragment entity together with the fragment body.

Although fcs defines how context information is delivered to a user agent, it says nothing about how that information should be used in the user agent to, for example, navigate within the parent document; those tasks are left for applications to handle. Therefore, utilizing fcs for partitioning of documents requires implementation of a system for processing that context information.

Fcs is written using XML syntax and uses two namespaces: the Fragment Interchange namespace and the parent document's namespace. From the Fragment Interchange namespace, fcs gets its root element and a special empty element that is used to indicate the placement of the fragment body in the parent document. From the parent document's namespace, fcs gets all of those elements that it needs to represent the hierarchy of the document fragment in situ. There is no mechanism, however, for parsing out a structurally self-contained or semantically coherent fragment. A “structurally self-contained fragment” is defined herein as a fragment that does not include merely part of a paragraph or merely part of an image. A “semantically coherent fragment” is a fragment that is a logical unit understandable without the need for information on the context of the element in the document.

IBM's Tokyo Research Laboratory has been developing an authoring tool for web content transcoding that uses the CC/PP framework to mark web content with metadata that can then be used in content negotiation to determine which parts of the HTML document should be sent to the recipient. See, Masahiro Hori, Kouichi Ono, Goh Kondoh and Sandeep Singhal: Authoring Tool for Web Content Transcoding, Proc. of the Markup Technologies '99 Conference, Philadelphia, Pa., USA (1999). CC/PP is an acronym for Composite Capability/Preference Profiles, a collection of capabilities and preferences associated with users and the devices employed by the users to access content via the World Wide Web. The above-mentioned metadata can also be used together with a user agent's CC/PP data to determine, by way of illustration, whether to send an image as a color or grayscale image or perhaps not at all depending, for example, on a user agent's rendering capabilities, the connection bandwidth, or the importance value that the image has been assigned.

IBM's system uses external annotation files which contain hint information that is associated with elements in the original document. That hint information can define, for example, alternative representations for a subject element, the alternative representations' fidelity as compared to the original, grouping information for a set of elements that must not be partitioned to separate fragments, a user agent's hardware or software capability requirements for an element, characteristics of a resource (e.g., minimum bandwidth requirements for streaming video), role of the element in the document (e.g., proper content, advertisement), and/or an element's importance value.

IBM's partitioning proxy needs to have at least one annotation file for each requested document to properly function. In order to aid the annotating process, IBM has developed a WYSIWYG (“What You See Is What You Get”—a visual design method) annotation editor by extending an existing authoring tool, namely IBM's TopPage. With the annotation editor, users can specify portions of HTML documents to be annotated at the time and set partitioning vocabulary attributes for those portions.

IBM's partitioning engine relies on an annotation tool that is used to semi-manually add metadata for each HTML document. This is a very time-consuming task if the document to be annotated is particularly large, as is often the case.

The Digestor system is an attempt to make a system for device-independent access to HTML documents. T. W. Bickmore and B. N. Schilit, “Digestor: Device-Independent Access To The World Wide Web”, Proc. of the 6^{th} International World Wide Web Conference, Santa Clara, Calif., USA (1997). The Digestor system aims to automatically adapt arbitrary HTML document contents and to appropriately display them on small screen devices such as PDA's and cellular phones. Digestor dynamically adapts the contents of the requested Web pages using a heuristic planning algorithm and a set of structural page transformations to achieve the best looking document for a given display size. The authors of the above-cited document do not provide many examples of Digestor's performance, but they claim that “It has been informally tested on a wide range of pages for a number of screen sizes, and it produces output which is always legible and navigable, although not always as aesthetically pleasing as one would like.”

As will be appreciated from these various studies, there is currently no single system that satisfactorily answers or addresses the entire problem. Different aspects of the problem are separately discussed, such as content negotiation and fragment interchange. There also exist attempts to partition HTML documents but, because of the non-well-formed nature of HTML, the heuristics used in those approaches tend not to be generalizable for application to XML. A new method for XML document partitioning that draws on the best parts of heretofore introduced technologies and bridges the missing gaps is therefore needed.

### SUMMARY OF THE INVENTION

The present invention is directed to partitioning a structured document having plural elements. A semantically coherent fragment of the document is built from at least one of the plural elements. The size of the fragment is compared to a predetermined threshold that is selected based on a characteristic of a receiving device configured to receive and render the fragment.

In another aspect, the present invention is directed to the partitioning of a structured document having labeled elements arranged so that the labels define a semantically-based hierarchy. First, metadata are attached to the labels. When a request is received from a device that is configured to render the fragment, the structured document is then partitioned based on the metadata to create a fragment having a size less than a predetermined threshold.

In a further aspect, the invention is directed to the parsing out of a fragment of a structured document which includes a plurality of elements for transmission to a receiving device that has requested the fragment. First, a file is created that maps metadata to each of the plural elements. The metadata is then linked to each of the plural elements in conformance with the file. Partitioning of the document is then performed in accordance with the linked metadata and predefined partitioning rules. A document fragment is thereby produced for transmission to the requesting receiving device.

In yet another aspect, the invention links metadata by a file and in a user device-independent manner to each of a plurality of elements of a structured document so as to arrange the document in a semantic hierarchy. In accordance with the linked metadata and predefined partitioning rules, the document is partitioned to produce a fragment for transmission to a requesting receiving device.

In a still further aspect of the invention, the partitioning of a structured document into a fragment is accomplished after elements of the document are linked to metadata, the linking being performed for the entire document without interactive control by a user.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1A illustrates the present invention in an information flow diagram;

FIG. 1B is a flow chart further describing the information flow in FIG. 1A;

FIG. 2 is a functional block diagram of an implementation of the present invention;

FIG. 3 is a flow chart demonstrating annotation in accordance with the present invention; and

FIGS. 4-16 are flow charts showing the application of partitioning rules in accordance with the invention.

### DETAILED DESCRIPTION OF THE CURRENTLY PREFERRED EMBODIMENTS

Information desired for retrieval by a mobile terminal (e.g., a PDA, mobile phone, laptop) is often found in a structured document, which is a document that includes symbols defining its structure. An example of a format for a structured document is Hypertext Markup Language (HTML), which is widely used in Internet applications; another example is Extensible Markup Language (XML). Both these languages identify data using bracketed or delimiting tags. While HTML tags indicate how to display the bracketed data, XML indicates what the bracketed data means. Under XML rules for creating a well-formed document, a pair of brackets cannot overlap another pair. That is, one pair of brackets can only intersect another pair if one or the other of the pairs is nested within the other. This nesting implies a hierarchical relation among elements. An element's brackets or delimiting tags serve as labels that semantically characterize the element. In effect, the labeled elements are arranged so that the labels define a semantically-based hierarchy. For example, an XML statement that defines an element with the name “animal facts” may appear as: “<animal facts>animals are cute<goat>A goat is cute, because it's an animal</goat></animal facts>”. This element is named “animal facts”, and has, as its contents, the statement “animals are cute” and an element named “goat”, whose contents are the words “A goat is cute, because it's an animal”. An XML element's name will typically be chosen so as to describe the element's content. In the above XML statement, the nesting of the “goat” labels within the “animal facts” labels implies a parent/child relationship between the elements “animal facts” and “goat”, i.e., the element “goat” is a child of its parent element “animal facts”. Semantically, the content of the element “goat”, i.e. “A goat is cute”, is a subset of the content of its parent element “animal facts”, i.e., “animals are cute”. The “animal facts” and “goat” labels therefore define a semantically-based hierarchy.

Each document is optionally linked to a Document Type Definition (DTD), which defines structural rules for a document and more generally applies for a group of documents. Hierarchy can also be inferred from statements in the DTD. XML does not specify what is a self-contained structure or what combination of elements constitutes a semantically coherent structure; rather, the user can define his own markup language under XML, such as Extensible Hypertext Markup Language (XHTML), Extensible Stylesheet Language (XSL), XML Pointer Language (Xpointer) or Wireless Markup Language (WML).

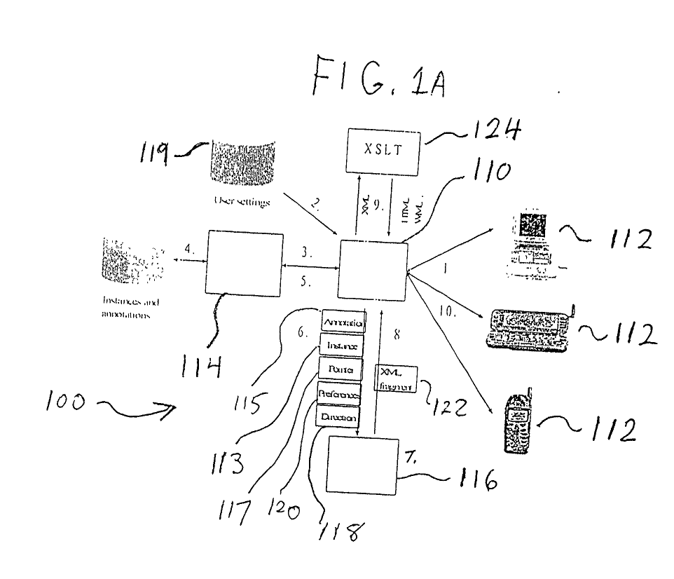

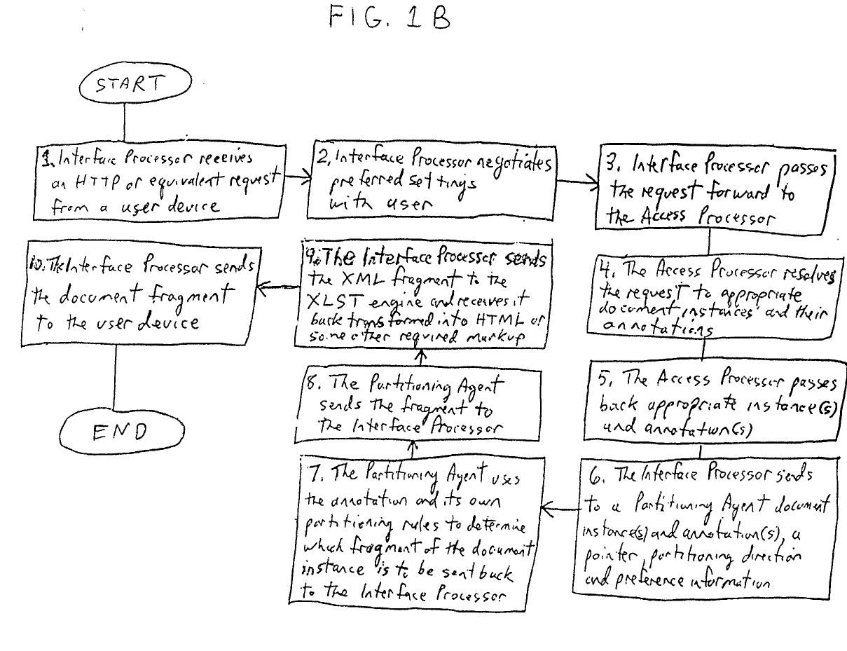

FIG. 1A depicts an exemplary partitioning system 100 in an information flow diagram numbered to correspond with the steps in the flowchart of FIG. 1B. The system 100 includes an interface processor 110 that receives requests 111 (step 1), typically in HyperText Transfer Protocol (HTTP), from user devices 112. The interface processor 110 negotiates (step 2) with the user any user preferences as to settings 119, and forwards (step 3) the requests to an access processor 114. The access processor 114 resolves (step 4) the request to appropriate document instance(s) 113 and their annotation(s) 115. In markup languages, such as HTML or XML, particular documents are referred to as “instances”. Here, resolving is needed because the request does not directly reference the instance(s) 113 and annotation(s) 115, although direct referencing is possible and is within the intended scope of the invention. The access processor 114 passes back the instance(s) 113 and annotation(s) 115 to the interface processor 110 (step 5). Provided with the appropriate instance(s) 113 and their annotation(s) 115, the interface processor 110 then sends them (step 6) to a partitioning agent 116. The interface processor 110 will typically include in the transmission a pointer 117 to a particular point selected by the user in the document instance 113. Also included in the transmission is a partitioning direction 118 and user preferences 120, depending on the information passed by the user device 112 with the request 111. The partitioning direction 118 is forward or backwards, representing respectively information further away from or further toward the root in the semantically-based hierarchy of structured document instance 113. The partitioning agent 116 uses the annotation 115 and its own partitioning rules 120 to determine which fragment 122 of the document instance 113 to send back to the interface processor 110 (step 7). The partitioning agent 116 then sends (step 8) the fragment 122 to the interface processor 110. In step 9, the interface processor 110 transmits the XML fragment 122 to the Extensible Stylesheet Language Transformations (XSLT) engine 124 for conversion into HTML or other required markup. HTML is herein described for use in communicating with user device 112 because XML is a relatively new system for markup languages and is not yet fully supported for universal implementation on all user devices 112; however, as XML use becomes more prevalent in user devices, the herein-described conversion to and from HTML may be eliminated. In any event, the interface processor 110 receives the transformed fragment 122 and forwards it to the requesting user device 112 (step 10). User devices 112 may be the clients for which the rest of the partitioning system 100 is a server. The specific structures shown in FIG. 1A have been presented therein as merely one example of a system that operates under the principles of the invention. Thus, for instance, in another embodiment, the request may directly reference the document instance desired, and the access processor 114 may therefore be eliminated. Similarly, the division of processing between the interface processor 110 and the partitioning agent 116 is not a necessary feature of the invention.

In dynamic partitioning, the partitioning process is performed after a request is received for a document, while in static partitioning the fragments are preproduced earlier and those ready-made fragments are served upon request. A system utilizing static partitioning can only serve fragments that are the outcome of partitioning with a fixed set of partitioning hints or constraints, whereas dynamic partitioning allows for partitioning with unlimited partitioning rules. Thus, dynamic partitioning enables a very flexible system that can easily adapt to new user agents that require fragments of a given document instance that differ from those required by the previous devices. By contrast, a static partitioning system needs to store all these fragments which means that such a system needs many times more disk space for the same documentation than a static partitioning system. Table 1 below compares dynamic and static partitioning:

TABLE 1

| | Pros | Cons |
|---|---|---|
| Dynamic | Flexible, adapts to new user | Needs on-the-fly processing |
| partitioning | devices | (may cause slowness) |
| Static | Fast (no on-the-fly | Does not adapt easily to new |
| partitioning | processing) | user devices, but requires a |
| | | fragment database update |
| | | after each supported user |
| | | device addition. |

Should a new user device with different needs for acceptable content be released, a static partitioning system needs to update its document fragment repository to additionally contain fragments that are suitable for the new user device. On the other hand, a disadvantage of dynamic partitioning is the extra processing that must be carried out for each document fragment request, since a new fragment must be generated from the original document. Special attention is needed to make this process as smooth as possible so that it does not significantly slow down delivery of the document.

The ultimate goal of document partitioning is to improve the accessibility and usability of documents. Partitioning makes it possible either to access documents via new devices or to render them in a new way allowing, for example, mobile Internet connectivity or more usable and efficient document use for user devices that were previously able to access the same information in a different way. Partitions of documents are, by definition, smaller in size than the original document (although real-world solutions need to embed some metadata with the fragments). Small size allows shorter access times, which is especially important with large documents and with the relatively low network connection bandwidths currently used in wireless networks. Although not required for partitioning, user preferences are natural add-ons to partitioning rules. Preferences allow document partitions to be more customizable and thus more usable.

Many variables define how a particular document should be rendered in a given situation. Generally, the variables can be classified as being either required by the user device or user originated. User devices have certain restrictions that control the partitioning requirements. User originated requirements should dominate when the user device does not set limits but is capable of rendering more content than that which the user is willing to receive at a time.

Partitioning requirements that arise from the different rendering capabilities of users' devices may be determined by the user device hardware, such as maximum display size, or by software such as supported markup languages.

As the most complex and most mature user device, personal computers (PCs) are the natural point of comparison for all terminal devices. Although PCs significantly vary in their document rendering capabilities, they are the target user device for which almost all content has originally been prepared. To date, there have been few documents targeted for non-PC user devices that PCs could not also render. Depending on network connection bandwidth, on-line PCs are capable of rendering, for example, streaming multimedia 3D graphics, or arbitrarily complex sounds, with no loss in quality. When provided with sufficient network connection bandwidth, PCs have no rendering capability restrictions.

PDAs, on the other hand, have small displays and small keyboards or an electronic pen with hand-writing recognition for receiving input. PDAs are most often used for PIM (personal information manager) functions, such as a calendar and address book. Their typically small screens permit only limited visual rendering capabilities, especially for larger images. They also tend to have computational power that is roughly one quarter of that of a PC. For the most part, PDAs can display text in an acceptable manner, although not as well as PCs. A PDA's network connection generally relies on a mobile phone, which currently means a relatively slow connection which, in turn, establishes restrictions on streaming media and other content.

The newest user device in the field, WAP-enabled mobile phones, provide direct access to the web via a WML (wireless markup language) server. The tendency towards producing smaller and smaller units sets many restrictions for rendering capabilities. Small size prevents the use of mechanical coolers, such as fans, for device elements, which means that less powerful processors can be used, especially as contrasted with PDAs. Screens on mobile phones also tend to be small, typically capable of only five to seven lines of graphical display. Relatively low on memory and with size-limited input devices, WAP phones set very different constraints for document content from PCs. At the moment, WAP phones only support black-and-white images. There is currently also a size limit for content that can be accepted by a WAP phone as one stream or packet, which sets further restrictions on images and other content that cannot be combined from several streams. Text rendering in WAP phones is also quite limited, since a screenful of text is typically between 50 and 150 characters of text. Moreover, the network connections are currently quite slow, although that situation should notably increase in the coming years.

If the user device does not set rendering restrictions, then the user needs to establish them in order to avoid delivery of, for example, a thousand page long manual for rendering on the screen. Apart from the setting of restrictions to avoid information overflow, users may also establish preferences to disable sound or images, to set the preferred language, or to select whether or not to display pages with frames, by way of example. Users may also wish to choose the extent to which they obtain information, such as in the form of thumbnail images from larger images, titles only, abstracts from textual contents, etc.

Large documents, such as manuals, are more likely to be read on desktop computers than on small devices. Small devices are more suited for reading short documents, such as help documents for a particular situation. In both cases, document partitioning is useful but is especially important in the latter. The most critical documentation to be partitioned is documents that are likely to be used with small, typically portable devices.

Following are some scenarios in which document partitioning becomes necessary or desirable.

Hardware installation may take place in uncomfortable or awkward locations, such as atop a radio tower. In such places, it is very inconvenient to hold or operate even a laptop—at best, only a PDA can be comfortably and safely used. Installation guides tend to be monolithic documents, and it is therefore necessary to locate or identify only the relevant information for rendering at any particular time. In using a PDA, a document fragment should ideally be rather short, preferably about, or less than, the size of one printed page. A typical installation documentation fragment might be a block that describes the steps needed for accomplishing an installation subtask. Although most PDAs can handle images, rendering of large images requires awkward scrolling and, therefore, the preferred document form to be elicited by the user device is text-only, with only small images. Moreover, rendering content aurally might be highly preferred in such a situation. An alarm that is sent as a Short Message Service (SMS) message to someone working in the field might contain, for example, the alarm code and an identification of the network element that caused the alarm. In such case, the needed documentation may be an alarm description manual and perhaps a troubleshooting guide or help document, depending on how familiar the alarm receiver is with the alarm type and the actions that it requires. Alarm descriptions are a type of document that a user device, with its limited rendering capabilities, must be able to render. In this instance, the document is rendered on a WAP mobile phone, and the preferred document fragment contains only the description of the received alarm code. After the user has read the description and gained knowledge on the alarm type, the user might still need to read more documentation to decide which actions should next be taken. The needed information in such case is presumably a task sequence, i.e. step-by-step instructions on how to repair or respond to the problem that caused the alarm. In either case, the preferred document fragment is likely quite small, perhaps a quarter of a printed page or less. Because of the WAP phone's limited rendering capabilities, the document should be renderable as text-only.

As another example, a company manager, using a laptop, is reading product descriptions to evaluate a product's suitability for the company's needs. The user may be browsing through various documents to form an opinion of the overall suitability of the product from a particular viewpoint. This kind of document usage requires a holistic picture of the documents. Specific details, such as steps to accomplish a task, are irrelevant here. Browsing through a large collection of documents also sets requirements for the navigation: it must be easy to access other parts of the current documents as well as all other related documents. In this case, images are preferred over text because they allow one to gain a rapid overall opinion of the product, including its functionality and components. Various abstracts, introductions and summaries are also preferred documentation in this case. A laptop computer does not necessarily have strict rendering requirements, but allows for the rendering of large fragments of text, images, sound and video.

As still another example, a telephone operator on a network wishes to make sure that he correctly understands the functionality of a particular application's dialog. The needed document fragment is very brief, describing only the very detailed information that is most likely located deep within the document structure. This situation sets very different requirements for partitioning from the previous example in which a high level of abstraction was preferred. In this case, the partitioning engine must be able to extract from the document the content that resides at the end of the document's structural hierarchy.

The above scenarios are only a few of the examples of how the present invention is applied, and, by their mention here, do not limit the scope of the invention.

There are clearly many different requirements that affect the partitioning process. The most critical are those that must be fulfilled, failing which the content cannot be rendered on the user device. Those requirements that make content viewing more usable are also highly preferred, but are not as critical. The requirements in the first category are typically a problem for user devices that have relatively limited rendering capabilities; small screen size, low memory, slow network connections and limitations in supported content types are likely to cause problems. To overcome those limitations, the partitioning agent must be able to partition documents into very small pieces when necessary, as for example for display on a WAP mobile phone with its small screen, slow network connection and limited size for a data stream that can be received at any given time. Such a user device must be provided with sufficiently small fragments of a document. The device may also need content-type conversions before the device can accept the document. Of those requirements, content-type conversions remain outside of the partitioning agent's scope, but partitioning of XML documents to arbitrarily small fragments is a requirement for the partitioning agent. This requirement also means that the partitioning metadata that is sent to the user device with the document fragment should take up as little space as possible.

In extreme cases, a document might have such content that, despite content-type conversion, only part of the content is renderable using a particular user device. For example, a very large image cannot be sent to a WAP phone or to many PDAs. In a such case, the partitioning agent must be able to send to the user device that part of the document that it can accept, and inform the device about the remainder that the user device could not accept.

If a document is partitioned into several fragments, the partitioning agent must also enable navigation between the fragments in such a way that the user does not get lost in the document.

The present invention is effective for partitioning documents written in any custom markup language created with XML, whereas the IBM system applies only to HTML. The partitioning environment of the present invention handles the needed annotation automatically, as contrasted with the semi-automatic operation of the IBM system.

To automatically annotate XML documents, something must be known about the semantics of the documents to be partitioned. A partitioning-specific vocabulary is developed that can be used for any XML documents. It is desirable to make the vocabulary as small as possible while still permitting its use to identify all of the features of an XML document that are relevant to partitioning the document into smaller fragments. That vocabulary is referred to as XML Partitioning Vocabulary (XPV). To enable automatic annotation, there must be a way to add the XPV metadata to the correct locations in any kind of XML document. At present, that task cannot optimally be done in a totally automatic maimer, and an extra layer is therefore added for mapping each document class (DTD) to the XPV. For each DTD there should be a mapping file that identifies which elements in that DTD should be annotated with the XPV metadata. The mapping file is used for mapping metadata to each of the plural elements of the document.

The actual partitioning process relies on the XPV annotation, but a partitioning application must know what to do in each partitioning situation. Therefore, a rule set referred to as XML Partitioning Rules (XPR) has been defined.

The partitioning agent receives as an input the XML document annotated with the XPV. The partitioning agent also needs to know the maximum size of the fragment in each situation, and whether the user wants a next or previous fragment, i.e. the partitioning direction. Provided with this information, the XPR should be able to determine how to form a suitably sized fragment of any XML document.

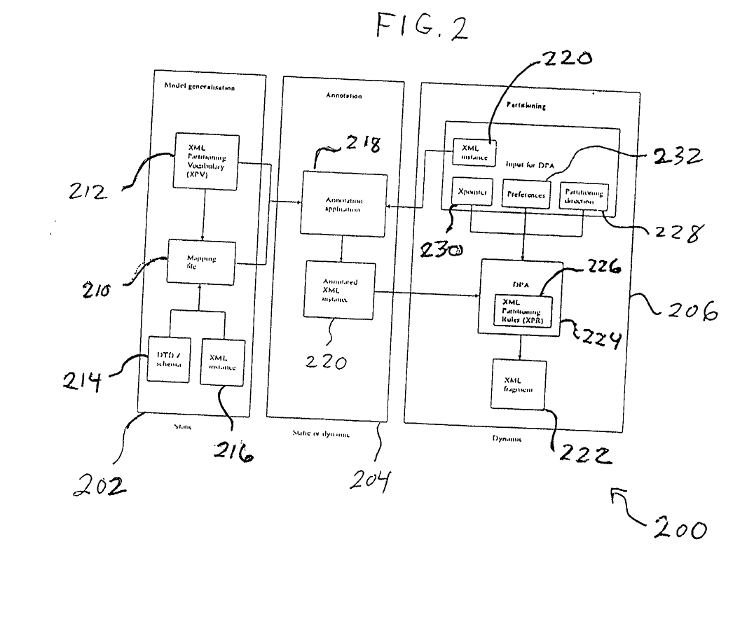

FIG. 2 depicts a functional block diagram of an exemplary processor or partitioning framework 200 in accordance with the invention. The framework 200 consists of three functional parts: XML document model generalization by a model generalization application 202, its instance metadata creation (annotation) by an annotation application 204, and partitioning by a partitioner 206 using the metadata. Metadata is data that describes other data.

The result of the model generalization is a mapping between an XML instance's own vocabulary and the metadata used in partitioning. XML provides for DTDs or schema; although differences exist between them, both terms are interchangeably used herein. They are files that contain a formal description of the document that they reference and specify which elements are allowed in the document. A DTD or schema is intended to apply to a plurality of similar documents, which is referred to as a document domain. The metadata of the instant invention used in partitioning is the XML Partitioning Vocabulary (XPV). As seen in FIG. 2, a mapping file 210 is created to establish a relation between XPV 212 and the DTD 214 that applies to the document instance 216. Specifically, the application 202 applies XML partitioning vocabulary 212 to a DTD 214 to create a mapping file 210.

Advantageously, the mapping file 210 is usable to annotate any document instance in the domain specific to the DTD from which the mapping file 210 was created. Thus, a mapping file 210 generated for a structured document is usable for partitioning another structured document that is structured in a similar manner to produce other semantically coherent fragments. As with the original document, the other document includes a plurality of elements, and the application 202 applies the file 210 to map the metadata to the plural elements of that other document in the document domain.

Mapping the domain's specific vocabulary in the DTD 214 to the generic vocabulary of XPV 212 that is understood in the automatic partitioning process 200 does not remove the need for semantic analysis but allows that analysis to be carried out only once for each document domain. Part of that analysis involves a determination of the independence of an element of a document, which is a matter of subjective evaluation based on the documents of the domain; the process can nevertheless be fully automated, as, for example, through artificial intelligence. An independent element is one that can exist independently as a fragment 122, whereas a dependent element is joinable together with other elements to form a fragment 122.

The mapping file 210 will typically include a group of statements that each link a specific element name to an XPV attribute. For example, assume again that a particular document instance contains the XML statement: “<animal facts>animals are cute<goat>A goat is cute, because it's an animal</goat></animal facts>”. As mentioned above, this XML statement defines an element that is named “animal facts” that has, as its contents, the statement “animals are cute” and a child element named “goat”, whose contents are the words “A goat is cute, because it's an animal”. If an element named “animal facts” appears in a document instance that is within the domain of a particular DTD, the following statement appears in that DTD: “animal facts” is: <!ELEMENT animal facts (goat)>”. The DTD statement indicates that any element named “animal facts” in any document instance in the DTD's domain has a single child element named “goat”. For simplicity of illustration, it will be assumed that the only independent elements in any document instance within the domain of the DTD are those named “goat”. The associated statement in the mapping file 210 which defines this relationship could be formatted as: independent/goat. This statement provides a list of the names of the elements in the domain of the DTD that are independent. In the instant case, this single mapping file 210 statement provides that in the domain of the DTD only a single element, named “goat”, assumes the XPV_dependency attribute value of “independent.” The fact that the element “goat” has a parent element, i.e. “animal names”, might suggest without more information that “goat” is, in fact, dependent. In this example, however, a subjective analysis in creating the mapping file 210 has determined that the nature of the content of the element “goat” is such that it can exist alone as understandable without the need for any context information. That is, the statement “A goat is cute, because it's an animal” has been determined to be independently understandable, without the phrase “Animals are cute.” Accordingly, the phrase “A goat is cute, because it is an animal” can make up a fragment that is displayable without its parent element “Animals are cute.”

The result of annotation step 204 is the annotation of an XML instance 216 with XPV 212. In the annotation or linking step 204 of FIG. 2, an annotation application 218 applies the mapping file 210 to the XML instance 216 to link metadata to each of the plural elements of the XML instance 216 and thereby create an annotated XML instance 220 that, like the XML instance before annotation, is arranged in a semantically hierarchical manner. Advantageously, and in contrast to the IBM annotating process for HTML files, the linking step 204 of the present invention is performed for the entirety of the document without interactive control by a user.

In the partitioning step, a partitioner or dynamic partitioning agent (DPA) 224 applies an Xpointer 230, user preferences 232 and a partitioning direction 228 to the annotated XML instance 220 to produce a document fragment 222. That is, the DPA 224 receives as an input a document instance 220 that has been annotated with generic vocabulary 212, a pointer 226 to the current location in the instance 220, and a partitioning direction 228. Partitioning rules 230 tell the DPA 224 what constitute suitable fragments for extraction from the instance 220 at hand, taking into account the expressed user preferences 232. DPA 224 then creates the fragment 222, provides it with proper information about its context in the instance 220 and distributes it further along.

The XPV 212 contains indicators (or in XML terminology, attributes) that can be added to XML elements. The XPV's DTD notation is as follows:

<!ENTITY % xpvattrs “XPV_structural (structural | content) ‘structural’

| “XPV_dependency (independent \| dependent) ‘independent’ | |
|---|---|
| “XPV_role (header \| title \| block) | #IMPLIED |

| | | |
|---|---|---|
| “XPV_bytecount | CDATA | #IMPLIED |
| “XPV_header | CDATA | #IMPLIED> |

Alternatively, the annotation attributes may be defined in their own namespace for each document in the following way:

<document xmlns:xpv=‘http://www. XPV_namespace_domain.tld’>

Using XPV namespace the annotation is attached to the XML document instance 216 as follows:

<sample_element xpv:structural=“structural” xpv:dependency=“independent” xpv:bytecount=“1024”>

Two of the five attributes of XPV 212 listed above—XPV_structural and XPV_dependency—are set in the herein described implementation for each element to be annotated. The latter three—XPV_role, XPV_bytecount and XPV_header—are set when necessary. As seen in the above entity declaration, each XPV-annotated document has by default the value ‘structural’ for every element's XPV_structural attribute, and the value ‘independent’ for each element's XPV_dependency attribute.

The XPV_structural attribute is a structural indicator that defines whether an element is a structural or a content element; it is a structural element if (a) it contains at least one child node, and (b) none of its child nodes are “textual nodes.” A textual node is defined herein as a node whose content is textual data (characters) or binary data, such as images. If an element contains both child nodes that are textual nodes and child nodes that are not (i.e., if the node has mixed content), then it is a content element. Defining whether an element is a structural or a content element is done automatically in the annotation phase. The structural or content information added to the element via the attribute, i.e. the attribute's value, is needed to determine the partitioning rules that apply for a given element. A structural element can always be further split into other elements, but, while a content element can be split into chunks of text or chunks of binary content, it cannot be split into other elements. Structural elements therefore require different partitioning rules than do content elements.

XPV_dependency is an independence indicator that defines whether an element is structurally self-contained or semantically coherent.

XPV_role defines certain special element types or roles that are especially important for partitioning. The first of these possible roles is a header which is an element that is copied to all produced fragments that are within the header's scope, i.e. those portions of the document that are within the topic described by the header. A template is a typical header. Title is another possible value for XPV_role to identify a title or heading; it is used to provide a name for a document, chapter, figure, or other subpart of the document. Finally, a block identifies something that must not be partitioned. Typically, a block is binary data (such as a figure), or a reference, or an action (such as a script or a trigger), or a GUI element (such as a push button).

XPV_bytecount is a size indicator that is use to store the results of a count of the bytes of content elements. The counts are cumulatively added to the root element, so the XPV_bytecount indicates the total size of all elements hierarchically linked as descendants of an element. The byte count is used in the partitioning phase to determine whether or not an element fits into a fragment that is size limited, as for example by architectural characteristics of a user device. The bytecount attribute is calculated automatically in the partitioning phase.

XPV_header, although unnecessary for partitioning, provides a convenient indicator as to whether an element has a header. The XPV_header attribute is set in the annotation phase for all elements that are within the scope of the header of an element whose XPV_role attribute is “header”. The XPV_header attribute thus indicates whether there is a header to be joined to the fragment to which the current element belongs. The content of an XPV_header attribute is an Xpath (an addressing mechanism for XML documents) to the header element. If an element is within the scope of more than one header, then each header's location will be put in the same attribute in the form of an ampersand (‘&’) separated Xpath list.

The annotation process 204 in accordance with the invention can be carried out in a number of different ways using a variety of different tools. In the following example, a DOM (Document Object Model) parser is used to traverse the tree structure of the document instance 220. Fragments 222 of a document instance 220 can be thought of as a tree being viewed through a window, where only part of the tree can be viewed at any time. Fragments 222 are therefore akin to subtrees in the “tree hierarchy”, starting from a particular node. Annotations are typically stored externally in a separate metadata file or in the memory of partitioning agent 224, although they can also be written internal to the document instance 220.

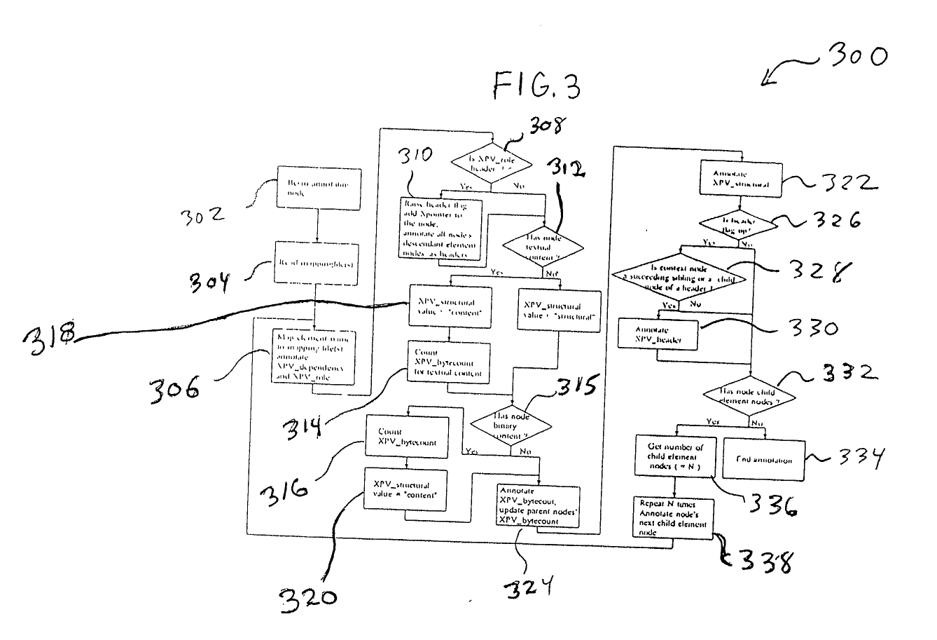

With reference now to FIG. 3, a node is annotated (step 302) by reading a mapping file 210 (step 304) and mapping an element name to the mapping file 210 (step 306) so as to indicate whether the element should be annotated as independent, header, title or block. If the element is a header, as indicated in the XPV_role attribute (step 308), a header flag is raised (step 310). In addition, an Xpath is stored to be added later to elements in the scope of the header. All descendant elements are annotated with the attribute XPV_role=“header”.

If an element has textual content as its direct child node (step 312), the byte count is determined for that content (step 314). If the node has binary content (step 315), the byte count is increased accordingly (step 316). In both these cases, the node's XPV_structural attribute's value is set to “content” (steps 318 and 320). Those elements that are not set as content nodes remain identified as structural nodes, which is the default value. After both textual and binary contents have been checked, the XPV_structural and XPV_bytecount attributes are annotated (steps 322 and 324). In addition, the element's parent elements' byte count attributes are updated to include their child nodes' byte counts (step 324). If the header flag is up (step 326) and the element is within the scope of a header (step 328), then the XPV_header attribute is set for that element (step 330). If the element does not have child elements (step 332), the annotation process ends (step 334). If, on the other hand, the element has child elements, then the annotation process is iterated once for each child element (steps 336 and 338); this iteration process continues recursively until the very last element in the document order is reached, at which point the annotation procedure halts. “Document order” is herein defined as the order in which the first character of the XML representation of each node occurs in the XML representation of the document after expansion of general entities. Thus, the root will be the first node. Element nodes occur before their children. The document order accordingly arranges element nodes in the order of occurrence of their start-tag in the XML (after expansion of entities).

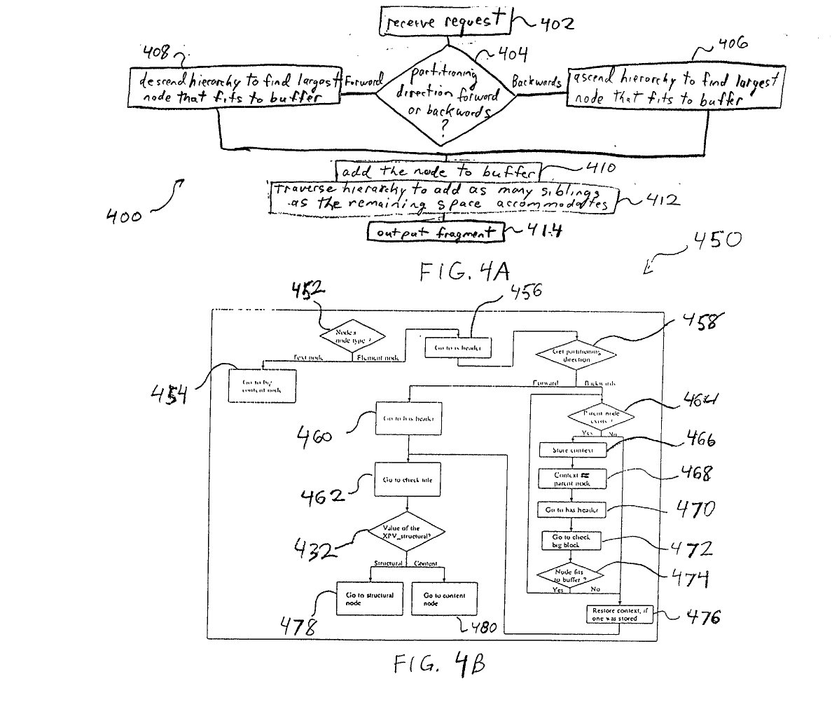

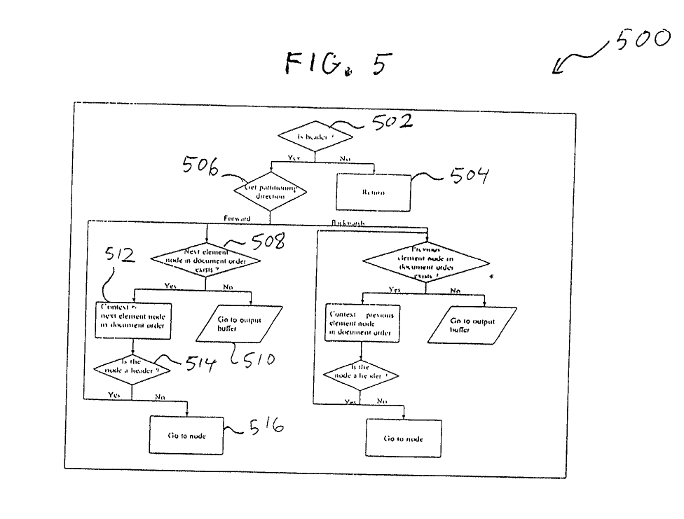

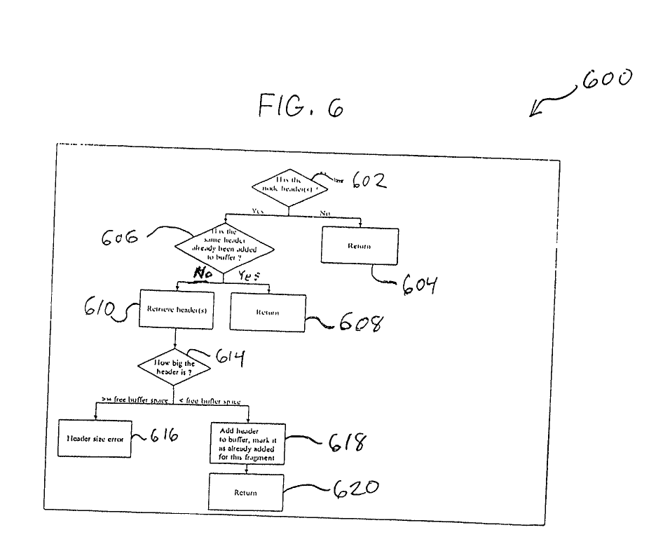

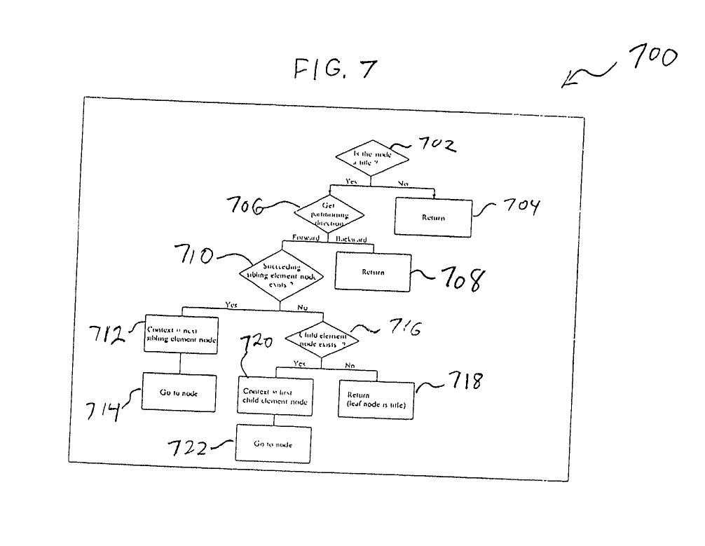

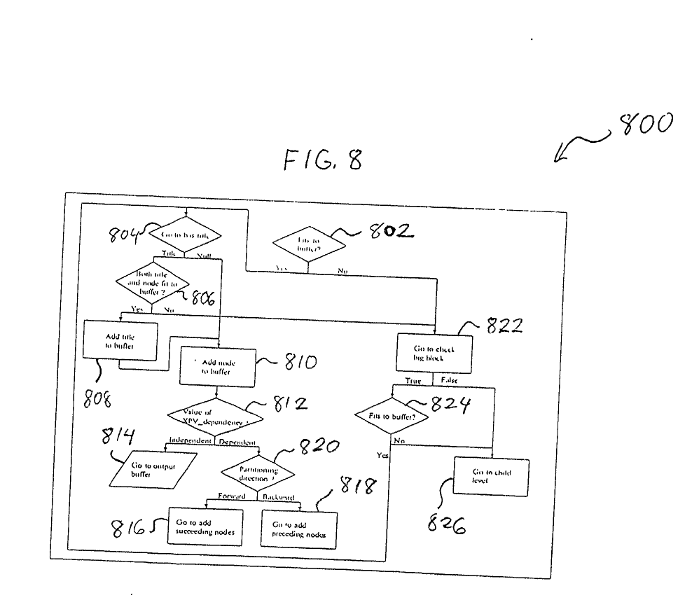

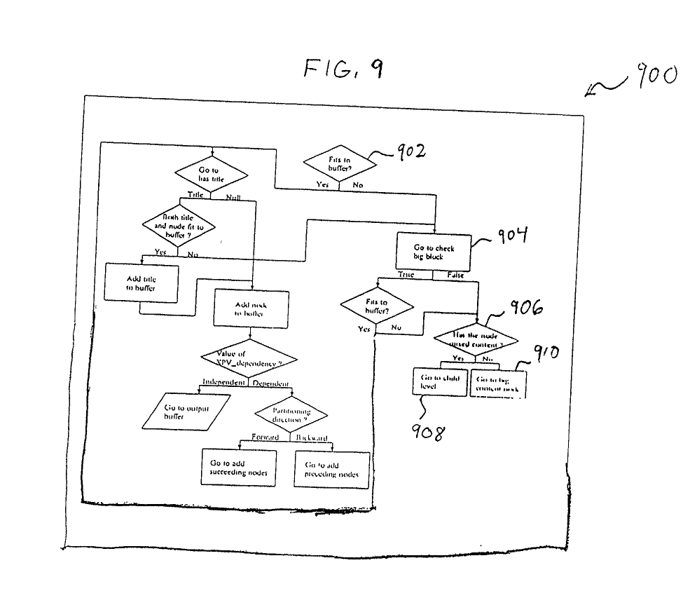

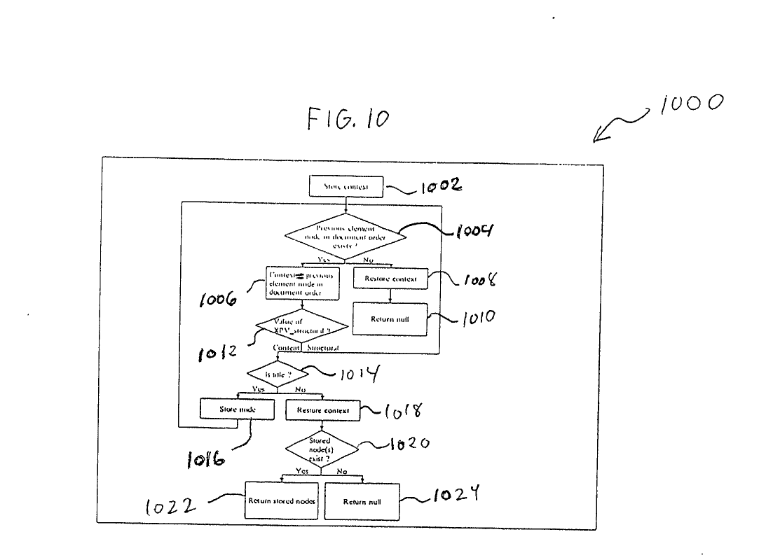

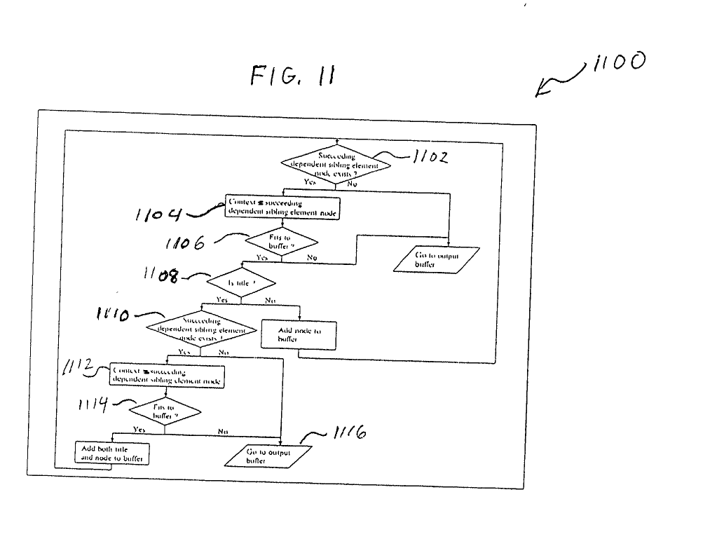

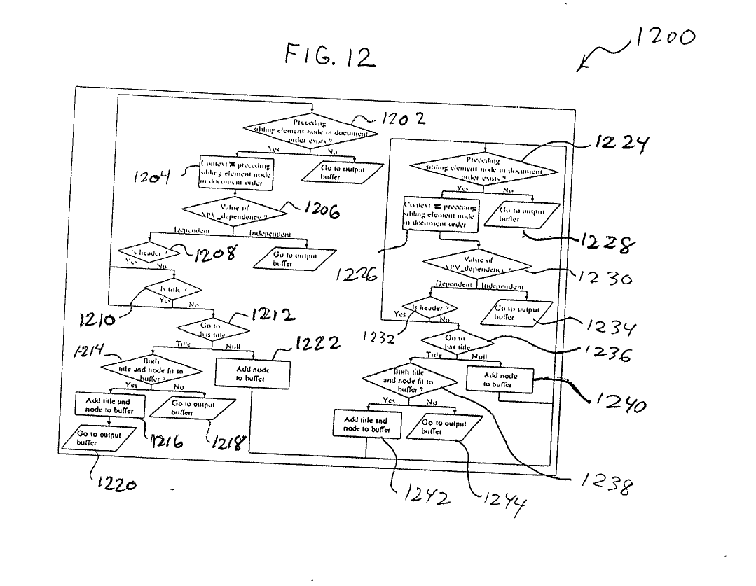

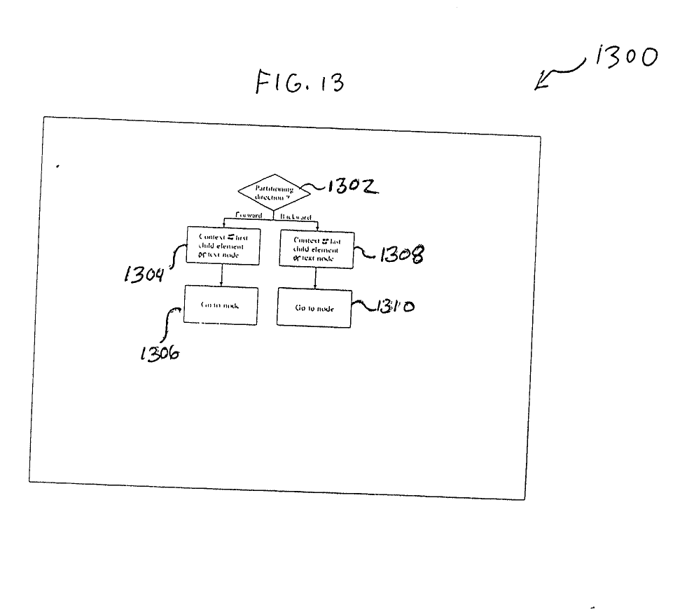

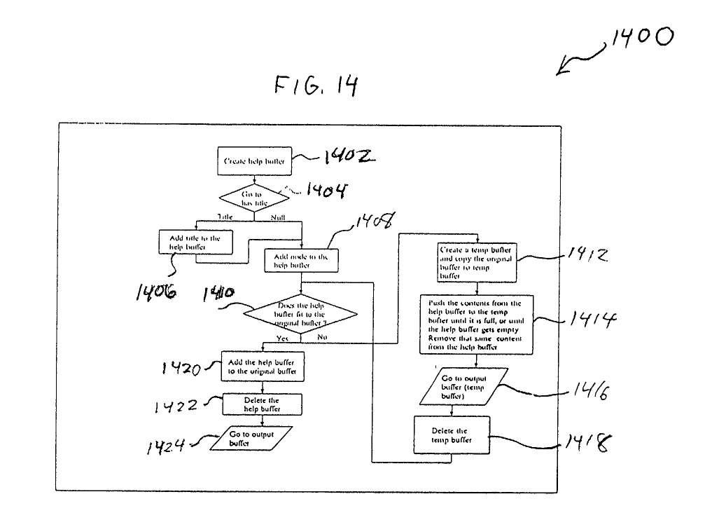

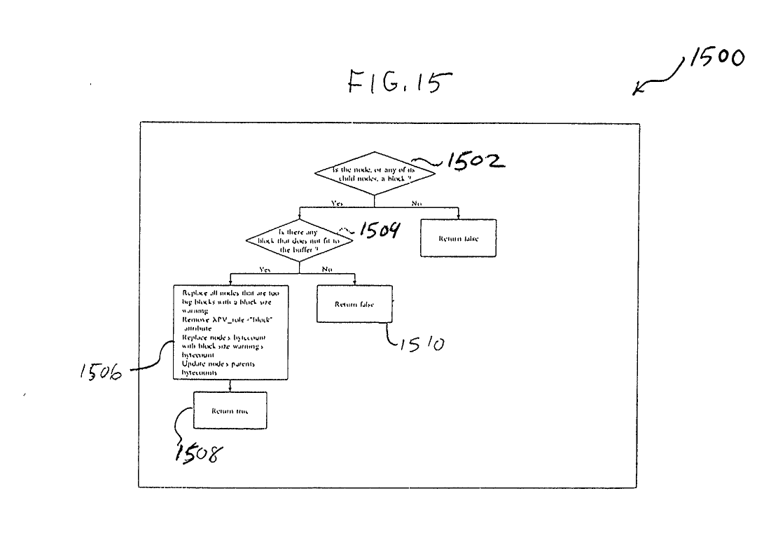

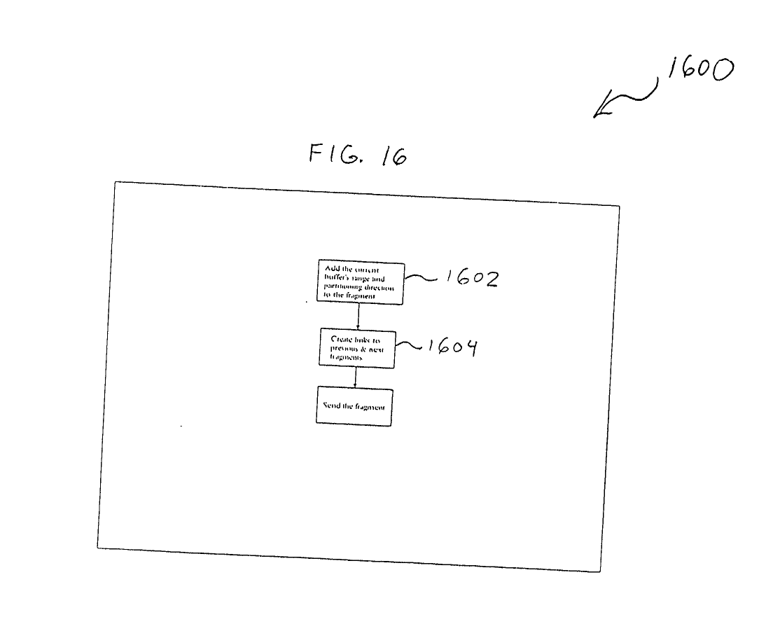

FIGS. 4-16 depict by way of illustrative example an implementation of partitioning in accordance with the present invention using XPR 230 (FIG. 2). In the figures and the following description, the node currently being operated on is referred to as the context node. Where the node being discussed is implicitly clear, the word “node” will be used. In the figures, references to “Go to xxx” identify the name (xxx) of the destination flowchart.

The present invention advantageously provides as much information for rendering by the user as possible, subject to architectural limitations and preferences that the user has specified, to assemble a fragment 342 of maximum size. Each of FIGS. 4-16 illustrates a corresponding subprocess 400 through 1600, respectively.

To form a fragment 222, the XPR 230 requires as an input the annotated document instance referenced by the requesting user device 112, the starting XPointer 226 (the default is to start from the beginning, if no Xpointer is provided), the partitioning direction 228, and user preferences which may include a partitioning buffer size 340. At the start of the partitioning process, a buffer 342 of size 340 is created for each fragment 222, the size 340 being below a threshold based on user preferences and other factors such as architectural limitations associated with the user device 112. The threshold may also be based on the bandwidth available to the user device 112, the size of a memory area for illuminating the display pixels on the device 112, and the type of the type of device 112, and may be determined by the DPA 224 or the device 112. The threshold may be incorporated into an initial request from the user device 112 and maintained constant during a session between the device 112 and processor 200 or, alternatively, updated through requests during the session. In particular the user device 112 may have a display or screen 113 of a particular screen size 115 which physically or architecturally limits the amount of image information renderable at any time and, thus, the size 340 of the buffer 342.

It should be noted that the linking or annotation step 204 is preferably performed in a manner independent of the characteristics, such as architectural limitations of the user device—i.e. in a user device-independent manner. Characteristics of the user device that requests the fragment are taken into consideration only in the subsequent partitioning step. Thus, for example, the buffer size threshold is not needed by the processor during annotation, but is used in partitioning.

FIG. 4A illustrates an overview of an exemplary partitioning technique 400 for building the largest semantically coherent fragment that can be rendered by the recipient user agent, subject to the limitation that the fragment fit to buffer 342. In essence, this technique is performed by, depending on the partitioning direction (i.e. forwards or backwards) (steps 402 to 404), either ascending (child-to-parent) (step 406) or descending (parent-to-child) (step 408) the hierarchy to find the largest node that will fit to buffer 342, adding the node to buffer 342 (step 410), traversing the hierarchy horizontally (sibling-to-sibling) to add as many siblings to buffer 342 as the remaining space accommodates (step 412), and outputting the fragment built (step 414).

FIG. 4B depicts a node_subprocess 450, which corresponds to steps 404 to 414 in the partitioning technique 400. The node_subprocess 450 adds the node's header, if the node has a header, to buffer 342. Concurrently, if the partitioning direction is backwards, the processing ascends the tree hierarchy in a child-to-parent manner, and the most ancient predecessor node that fits into buffer 342 is located and made the context node. If, on the other hand, the partitioning direction is forward, the processing descends the hierarchy in a parent-to-child manner until a (context) node is found that fits to buffer 342. Whether the partitioning direction is forward or backwards, the context node is saved to buffer 342 and the hierarchy is then horizontally traversed to fit siblings into the remaining space of buffer 342.

The first step in node_subprocess 450 is the node type check (step 452), in this example using the Xpath data model. Although Xpath also has other node types, as a consequence of processing heretofore effected a node can at this point be of only two possible types: either a text node or an element node (assuming that no direct references to other nodes, such as attributes, will be present). The node is typically an element node, i.e. an element, although in unusual case may be a text node (step 454) if its parent was a large, mixed-content node undergoing a content_node_subprocess 900.

If the node is an element node, then the is_header_subprocess 500 (step 456) is performed. If the node is not a header, the partitioning direction is queried (step 458) and, if the direction is forward, the workflow proceeds (step 460) to the has_header_subprocess 600 and to add the header or headers of the context node to buffer 342.

If, on the other hand, the partitioning direction is backward, the hierarchy is ascended in a child-to-parent manner to determine the context node to be added to buffer 342 and to concurrently add the context node's header or headers to buffer 342 (steps 464 to 476).

Specifically, if a parent node of the context node does not exist (step 464), no context will have been stored (step 476), the current context therefore remains in place, and processing for the backward and forward partitioning directions follows a common path in search of siblings that will fit to buffer 342. Otherwise, the context is stored (step 466), and the parent node becomes the context node (step 468). If header(s) of the context node exist, they are added to buffer (step 470) in the has_header_subprocess 600. A branch is then made to the check_big_block_subprocess 1500 to determine whether or not the node contains any blocks that are too big to fit to buffer (step 472). A comparison is made between the size of the node and the size of the buffer 342 (step 474). If the node does not fit to buffer 342, the node can no longer remain the context node, because the context node is to be saved to buffer 342; consequently, the saved context node is made the context node (step 476). On the other hand, if the node does fit to buffer 342, another iteration is required to determine if the node's parent node fits to buffer 342, and processing therefore returns to the top of the loop (step 464). When context node is the root, so that the parent of the context node no longer exists (step 464), or when a context node is selected that does not fit to buffer (step 474), the context is restored, if one was stored (step 476), and processing proceeds through the check_title_subprocess 700 (step 462), as explained below.

After the check title step 462, the context node is forwarded to either the structural_node_subprocess 800 in step 478 or the content_node_subprocess 900 in step 480, depending on the value of the node's XPV_structural attribute.

The is_header_subprocess 500 (FIG. 5) has the function of skipping all nodes that are headers. For every node that is added to buffer 342 in other subprocesses, a check is performed to see if that node has a header. If so, then such headers are added in that respective subprocess, and must not therefore be added to buffer 342 in the is_header_subprocess 500.

If the node is not a header (step 502), then processing returns (step 504) to the previous subprocess; if it is, the processing direction is queried (step 506). If the processing direction is forward, a check is made as to whether a next element node in the document order exists (step 508); if not, the procedure branches to an output_buffer_subprocess 1600; otherwise, the context is set to next element node in the document order (step 512). If that next element node is not a header (step 514), then processing branches (step 516) to the node_subprocess 450 (FIG. 4B); if it is a header, processing iteratively turns or loops back to step 508. If the processing direction is determined in step 506 to be backward, then analogous steps are carried out, as shown in FIG. 5.

The has_header_subprocess 600 (FIG. 6) determines whether the context node has a header, or headers, and adds those header(s) to buffer 342 if they fit and have not already been added to buffer. A determination as to whether the node has a header (step 602) is carried out by looking at the node's XPV_header attribute. Where there is no header, processing returns (step 604) to the previous subprocess. If there is a header, the process queries whether the same header has already been added to buffer 342 (step 606) and, if it has, then processing returns (step 608) to the previous subprocess; if not, the context node's header or headers are retrieved (step 610). If the retrieved header(s) are too large to fit into the free buffer space (step 614), an error message is sent to the user device 112 (step 616) because the fragment 222 cannot be sent to the user. If, on the other hand, the free buffer space can accommodate the header(s), it is added to buffer 342, the addition of the header(s) is recorded (step 618), and processing returns (step 620).

The check_title_subprocess 700 does nothing if a node is not a title (steps 702 and 704) or if it is a title (step 706) but its partitioning direction is backward (step 708). Otherwise, for a title element node whose partitioning direction is forward, the check_title_subprocess 700 checks whether there exists a succeeding sibling element node in the document order (step 710). If so, the context node is set to that next sibling element node (step 712) and processing returns to node_subprocess 450 (step 714). If there is no succeeding sibling and a child element node does not exist (step 716), then the context node is not only a title but a leaf node, and no action takes place. A title will not be placed in buffer 342 alone; must be followed by some content that also fits in buffer 342, so that a fragment 222 can never end with a title. The addition of titles to buffer 342 is handled in other flowchart subprocesses. If a child element does exist, then the context node is set to the first child element node in the document order that has not already been buffered (step 720), and processing returns (step 722).

In the anticipated procedure of structural_node_subprocess 800, a node that fits into buffer 342 (step 802) is added to the buffer with its header if it has one (steps 804-810). Then, if the value of the node's XPV_dependency attribute is “independent” (step 812), it is outputted as a fragment 222 (step 814). If that value is “dependent”, on the other hand, it is possible that other element nodes will be concatenated to the existing contents of buffer 342 if they fit, in accordance with either the add_succeeding_nodes_subprocess 1100 or the add_preceding_nodes_subprocess 1200, whichever is invoked as a result of the partitioning direction (step 820).

If the node is too large to fit into buffer 342 in the first test, it is checked for blocks that are too large (step 822) by a check_big_block_subprocess 1500. When a block is identified that is too large, the same check as to whether the node then fits into buffer 342 is repeated (step 824). If the block is determined to not be too large, then the node camiot form a fragment 222 and must be further partitioned. In that case, the workflow is directed (step 826) to a child_level_subprocess 1300; this can be carried out without any checks because a structural node always has child elements.

The same check for a block that is too large is needed if a node fits into buffer 342 but its title does not (step 806). In such a situation, either the node has blocks that are too large which must be removed using the check_big_block_subprocess 1500) or the node must be split into smaller fragments 222.

The content_node_subprocess 900 is identical to the structural_node_subprocess 800 with one exception: if the context node does not fit into buffer 342 (step 902) and does not contain blocks that are too large (step 904), an additional check is performed. Where the node has mixed content (step 906), i.e. has both text content as its immediate child as well as other elements, it is further divided into its child level nodes (step 908), in which event, there arise one or more nodes that are not element nodes, but text nodes. To process them, there is a check in step 452 of node_subprocess 450. If the context node does not have mixed content, in which case it has only textual content, it must be partitioned to suitably-sized chunks of text which the user is willing to accept. That functionality is carried out (step 910) in a big_content_node_subprocess 1400.

The has_title_subprocess 1000 provides the following functionality: if the context node has one or more title element nodes (whose XPV_role's value is “title”) immediately preceding it in the document order, those nodes are stored (steps 1002-1016) and returned (steps 1018-1022) when no more immediately preceding title element nodes are found. If there are no element nodes immediately preceding the context node, the has_title_subprocess procedure returns nulls (steps 1010 and 1024).

The add_succeeding_nodes_subprocess 1100 adds to buffer 342 element nodes that immediately follow the context node in document order to maximize the size of fragment 222. There are, however, several exceptions in which the next node is not added to buffer 342 and the existing content of buffer 342 is outputted.

The first exception is where the context node does not have a succeeding dependent sibling element node (step 1102). The test for this identifies two situations that invoke the exception: if the node does not have a succeeding sibling element nodes, or it does and that node has “independent” as the value of the its XPV_dependency attribute. Such nodes are presumed to form their own fragments 222 and are not therefore catenated to other nodes.

The second exception is where the succeeding node does not fit into buffer 342 (steps 1104-1106). And even if the succeeding node fits into buffer 342 but is a title node that immediately precedes a node does not fit into the buffer (steps 1108-1114), the title node will not be added to buffer 342 (step 1116), since a title node must not be the last node of a fragment 222.

The add_preceding_nodes_subprocess 1200 functions in a manner similar to the add_succeeding_nodes_subprocess 1100, but the partitioning direction for subprocess 1200 is backwards. The context node's parent node can never fit into buffer 342 due to the check that has already been performed in the node_subprocess 450. Therefore, the function of subprocess 1200 is to add as many preceding sibling element nodes to the context node as will fit into buffer 342. Here, too, there are several exceptions that terminate the process and cause outputting of the buffer 342.

The first of those exceptions is where there is no preceding sibling element node for the context node, i.e. the context node is the first child of its container node. Another exception is that the preceding element node has “independent” as the value of its XPV_dependency attribute, in which case it is not added to buffer 342 for the same reason as mentioned above with respect to subprocess 1100.

When the partitioning process reaches the add_preceding_nodes_subprocess 1200, the has_title_subprocess 1000 has already been performed, either in executing the structural_node_subprocess 800 or in executing the content_node_subprocess 900. It is therefore, it is important to be certain that if the context node in the beginning of subprocess 1200 has any immediately preceding title nodes, they will not again be added to buffer 342. A loop back is accordingly implemented at the beginning of the add_preceding_nodes_subprocess 1200 if the context node has an immediately preceding title node (steps 1202-1210).

Once there are no more preceding title nodes (steps 1202-1210), i.e. the context node is a dependent, non-title node, the has_title_subprocess 1000 is performed once again (step 1212). If the context node has any preceding title node(s), they are added to buffer 342 (assuming that they fit) after which buffer 342 is outputted (steps 1214-1220). If, on the other hand, the context node does not have any preceding title nodes, then the process continues to the preceding sibling element node (steps 1222-1224). At that point, a loop begins that is similar to that explained above (steps 1224-1244), except that there is now no need to check whether the preceding title node(s) has already been added to buffer 342.

The iterative process of adding preceding sibling element nodes to the buffer then continues until either no additional preceding sibling element node exists (step 1228), or the node is independent (step 1234), or the node with its preceding title node (if it has one) does not fit into buffer 342 (step 1244).

The child_level_subprocess 1300 determines, based on the partitioning direction (step 1302), whether to continue from the first child element or child text node, or from the last child element or child text node, of the context node (steps 1304-1310).

The big_content_node_subprocess 1400 is invoked when a text content node is too large for the user device to accept. In that case, the textual content is split into smaller chunks that are separately delivered to the user device. Two additional buffers, the help buffer 344 and the temp buffer 346 are used in this subprocess in addition to the buffer 342 (the “original buffer”) that was being used when the big_content_subprocess 1400 was called. The original buffer 342 initially contains only the context node's header.

The help buffer 344 (created in step 1402) is larger than the original buffer 342 and is used to store all content that needs to be sent to the user device, i.e. the contents of the context node and optionally any title node(s) immediately preceding the context node. If the contents of help buffer 344 do not fit into the original buffer 342 (steps 1402-1410), as is always the case at the start of the big_content_subprocess 1400, the temp buffer 346 of the same size as the original buffer 342, is created (step 1412). To the temp buffer 346 is then copied the contents of the original buffer 342 (i.e. the header) and as much of the contents of the help buffer 344 as will fit into temp buffer 346, and the contents moved to temp buffer 346 are concurrently deleted from the help buffer 344 (step 1414). Temp buffer 346 is then outputted (step 1416) and deleted (step 1418). If contents of help buffer 344 still do not fit into original buffer 342, they are iteratively transferred to the user through new temp buffers 346 until the remaining contents of help buffer 344 fit into original buffer 342 (steps 1410 and 1420). Help buffer 344 is then deleted (step 1422), and original buffer 342 is outputted (step 1424).

The check_big_block_subprocess 1500 checks through the context node and all of its child element nodes, looking for nodes whose XPV_role attribute is “block” (step 1502). If such a node is found, it is checked against free buffer space 612 (step 1504) and, if it does not fit into buffer 342, it content cannot currently be sent to the user device. The node must therefore be replaced with an appropriate message informing the user that he cannot properly receive that content (step 1506). The user can then modify the fragment size limiting preferences 232 to permit receipt of the content, if possible. Where the user device 112 has hardware or software restrictions that prevent it from accepting that large a block, such content cannot be transmitted to the user device.

When the check_big_block_subprocess 1500 has identified a block too large to send to the user, it replaces the node, the value of its XPV_bytecount attribute, and the XPV_bytecount attribute values of the parent nodes. The previous subprocesses in the partitioning process can then be reinvoked to determine whether the context node will perhaps now fit into buffer 342.

If the block is too large, the check_big_block_subprocess 1500 returns “true” (step 1508); if not, it returns “false” (step 1510).

The output_buffer_subprocess 1600 forms the fragment 222 by adding (step 1602) to fragment 222 the range of the buffer in Xpath format (start and end element nodes, excluding header) and links 352 to the previous fragment and the next fragment (step 1604). The space needed for those links must always be reserved in buffer 342.

The link 352 to the previous fragment does not reference a fixed point; instead, it specifies a range 354, coextensive with the current fragment 222 excluding its header and the partitioning direction 228, i.e. backwards. Link 352 therefore references the previous sibling element node in the document order, counting from the first element in the range 354 of buffer 342. If there is no previous sibling element node, then it references the range's parent node's contents (not the element itself), if it is a content node. If it is not a content node (i.e. it is a structural node), then the link references the range's parent's previous sibling element node. If that does not exist, then the same iteration goes on (parent node's contents if the parent node is a content node, otherwise parent's previous sibling element node) up the document hierarchy until a matching node is found, or the root node is reached. If a matching node is found, a link 352 to the previous fragment is added to the current fragment 222; otherwise, the root element has been reached, and a link 352 to the previous fragment will not be added to the current fragment 222 since there is no prior fragment.

Accordingly, the link 352 to the next fragment references the buffer range's next sibling element node, or the next sibling element of its parent node, or the next sibling element of its parent's parent node, etc., until a valid node is reached. Failure to locate a valid node indicates that the buffer's range 354 covers the last element node of the document. In that case no link 352 to a next fragment will be added to the current fragment 222. The next fragment link 352 is also a variable reference, containing the range 354 and partitioning direction 228, which in this instance is forward.

A determination that the range is not a well-formed XML instance but rather a subset of a content node indicates that a large content node has been split in step 1414 of the big_content_node_subprocess 1400.

Operationally, a user wishing to navigate through a document beyond what currently appears on the screen of the user device selects a partitioning direction via an input means, such as a button, on the user device. The partitioning direction is forward when, for example, the user is seeking more detailed information, or backward when, again by way of example, the user wishes an overview of available alternatives. The user may also select via the input means user preferences, such as instructions that any relevant image may be split between subsequently displayed screens. The user operates the input means to issue the request for a next or preceding fragment in the document order for transmission back to the user device. The request also contains a pointer to the instance of the document to be rendered on the user device. The client receiving the request retrieves the instance identified by the pointer, that instance having been pre-annotated, and partitions that instance based on partitioning rules to form a fragment. The partitioning also takes into account the buffer size included in the request and any user preferences including any that have been negotiated upon receipt by the client. The result of partitioning is a fragment that is semantically coherent and structurally self-contained and is configured for maximum size subject to user device architectural restrictions and user preferences. The fragment, including links for forward and backward navigation, is returned to the user device for storage in an image buffer thereof and rendering on the user device display.

If no fragment meeting the size limitations is producible, portions of a fragment may be serially delivered to the user for display until the fragment has been fully displayed.

After the fragment has been displayed, and the user operates the user device to navigate forward or backward within the document, the screen is cleared and the next fragment in the partitioning direction is requested and received for storage and display on the screen of the user device.

In the herein-described embodiment, the displayed fragment may occupy less than the full screen display capability of the user device, so that some portion of the screen pixels may not be illuminated. Optionally, this unused portion can be illuminated with part of the next fragment (backward or forward, as appropriate) in the hierarchy, this next fragment being fully displayed when a subsequent screen is invoked.

While there have shown and described and pointed out fundamental novel features of the invention as applied to a preferred embodiment thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A processor for partitioning a structured document having plural elements, said processor comprising:
building means for building, from at least one of the plural elements, a semantically coherent fragment of the structured document, said fragment having a size; and
comparing means for comparing the fragment size to a predetermined threshold that is selected based on a characteristic of a receiving device configured to receive and render the fragment.

2. The processor of claim 1, wherein said building and comparing means are iteratively invoked, one after the other per iteration.

3. The processor of claim 2, further comprising sending means for sending said fragment to the receiving device, said sending means being invoked following a final iteration.

4. The processor of claim 1, wherein said elements are arranged in a tree hierarchy.

5. The processor of claim 4, wherein said building means builds said semantically coherent fragment by ascending the hierarchy in a child-to-parent manner.

6. The processor of claim 5, wherein said building means builds said semantically coherent fragment by traversing the hierarchy in a sibling-to-sibling manner after ascending the hierarchy in said child-to-parent manner.

7. The processor of claim 1, wherein said processor selects said threshold based on the type of the receiving device.

8. The processor of claim 1, wherein said processor selects said threshold based on an architectural limitation of the receiving device.

9. The processor of claim 8, wherein the architectural limitation is a display capability of a display of the receiving device.

10. The processor of claim 9, wherein the display capability of the display of the receiving device comprises pixels that are not illuminated.

11. The processor of claim 1, wherein said processor selects said threshold based on an amount of bandwidth available to the receiving device for receiving fragments of the structured document.

12. The processor of claim 1, wherein the receiving device is a mobile device.

13. The processor of claim 1, wherein the receiving device is a mobile telephone.

14. The processor of claim 1, wherein the structured document is written in a markup language.

15. The processor of claim 14, wherein the markup language is an XML application.

16. The processor of claim 1, wherein said building means builds a plurality of semantically coherent fragments, each of the plural fragments including context information to enable a user of the receiving device to navigate to another of the plural fragments of the document.

17. The processor of claim 1, wherein said building means builds a plurality of semantically coherent fragments, each of the plural fragment comprising links to a previous and a next fragment.

18. The processor of claim 17, wherein each fragment is semantically related to its previous fragment and next fragment.

19. The processor of claim 1, wherein said building means builds the fragment in response to a request from a user of the receiving device.

20. The processor of claim 19, wherein said building means builds the fragment in response to a request from a user of the receiving device to move in a partitioning direction within the structured document.

21. The processor of claim 1, wherein said building means builds a plurality of semantically coherent fragments and includes a means for labeling the plural elements of the structured document with a vocabulary indicative of a relationship of each of the plural elements to others of the plural elements in the structured document.

22. The processor of claim 21, wherein the vocabulary used to label each of the plural elements of the structured document comprises an indication as to whether the element has semantic content.

23. The processor of claim 21, wherein the vocabulary comprises an indication as to whether the element is a logical unit understandable without the need for information on a context of the element in the structured document.

24. The processor of claim 21, wherein the vocabulary comprises an indication whether the element is a header.

25. The processor of claim 21, wherein the vocabulary comprises an indication of a size of the element.

26. The processor of claim 25, wherein the size is cumulative of sizes of other elements hierarchically linked to the element.

27. The processor of claim 1, wherein the plural elements are labeled and arranged so that the labels define a semantically-based hierarchy.

28. The processor of claim 1, wherein the building means includes means for applying a file, that maps metadata to each of the plural elements of said document, to annotate each of the plural elements with the metadata.

29. The processor of claim 28, wherein said plural elements are arranged in a semantically-based hierarchy, said applying means further comprising means for annotating an element with a structural indicator indicating whether the element has at least one descendant in the semantically-based hierarchy and whether said descendents are all non-textual.

30. The processor of claim 28, wherein the building means further includes a partitioner for partitioning the structured document to produce said fragment in accordance with the mapped metadata and a predefined set of partitioning rules.

31. The processor of claim 30, wherein said partitioner is for partitioning another structured document that is structured in a similar manner to produce other semantically coherent fragments, the another document comprising a plurality of elements, wherein said means for applying uses said file to annotate each of the plural elements of the another document.

32. The processor of claim 28, wherein said means for applying annotates the elements with size indicators indicating a size of the respective element.

33. The processor of claim 28, wherein said means for applying performs said annotating in a manner independent of characteristics of the requesting receiving device.

34. The processor of claim 1, wherein said building means builds a plurality of semantically coherent fragments and at least some of the plural fragments are hierarchically produced by concatenation to the largest size that does not exceed the threshold.

35. A method for partitioning a structured document having labeled elements arranged so that the labels define a semantically-based hierarchy, said method comprising:
attaching metadata to the labels; and
partitioning the structured document based on the metadata to create a semantically coherent fragment having a size less than a predetermined threshold that is based on a receiving device configured to receive and render the fragment.

36. The processor of claim 35, wherein the fragment is formed so as to be structurally self-contained.

37. A method for parsing out a fragment of a structured document comprising a plurality of elements for transmission to a receiving device that has requested the fragment, the method comprising:
creating a file that maps metadata to each of the plural elements;
linking metadata to each of the plural elements in conformance with the file; and
partitioning, in accordance with said linked metadata and predefined partitioning rules, the document to produce the fragment to be transmitted to the requesting receiving device.

38. The method of claim 37, wherein said partitioning is performed so that the fragment has a size less than a predetermined threshold that is based on the characteristics of the receiving device.

39. The method of claim 38, wherein the threshold is included in the request of the receiving device.

40. The method of claim 39, further including the step of receiving said request, said request being received after said linking step and before said partitioning step.

41. The method of claim 40, wherein the receiving device comprises a display, and the threshold corresponds to a capability of the display.

42. The method of claim 41, wherein the display capability comprises pixels of the display that are not illuminated.

43. The method of claim 37, wherein said linking step is performed in a manner independent of characteristics of the requesting receiving device.

44. The method of claim 37, wherein said file maps to the elements independence indicators indicating whether the element is semantically coherent; and
said linking step includes the step of annotating the plural elements with the independence indicators according to the mapping in the course of traversing a hierarchy of said plural elements.

45. The method of claim 44, wherein the annotating step comprises annotating each of the elements with a structural indicator indicating whether the element has at least one descendant in the semantically-based hierarchy and whether said descendents of the element are all non-textual.

46. The method of claim 37, wherein said linking step is performed for the entirety of said document without interactive control of said linking step by a user.

47. A computer-readable medium of instructions, comprising:
a means for linking by a file and in a user device-independent manner metadata to each of a plurality elements of a structured document so as to arrange the document in a semantically hierarchical manner; and
a means for partitioning, in accordance with the linked metadata and predefined partitioning rules, the document to produce a fragment to be transmitted to a requesting receiving device.
